(19) United States
(12) Patent Application Publication
(10) Pub. No.: US 2026/0191217 A1
(43) Pub. Date: Jul. 9, 2026

(54) METHOD FOR PRODUCING DAIRY SUBSTITUTE PRODUCTS

(71) Applicant: MEURA S.A., PERUWELZ (BE)

(72) Inventors: Frédérique HARMEGNIES, BURDINNE (BE); Mathieu HAERINCK, MARBAIS (BE); Loranne LAMBIN, CORBAIS (BE); Pascal CANTILLON, HAVINNES (BE); Olivier SIMAL, LIMAL (BE)

(21) Appl. No.: 18/838,874

(22) PCT Filed: Feb. 16, 2023
(86) PCT No.: PCT/EP2023/053964

§ 371 Date: Aug. 15, 2024

(30) Foreign Application Priority Data
Feb. 18, 2022 (BE) BE2022/5110

(51) Int. Cl. A23C 11/10; A23C 11/06; A23L 11/60

(52) U.S. Cl. CPC A23C 11/103; A23C 11/06; A23L 11/60

(57) ABSTRACT

A method for the production of dairy substitutes, includes providing a suspension of a plant-based material containing compounds to be extracted, performing a solid-liquid separation by a plate filter press including at least one succession of filtration chambers and filter media, the solid-liquid separation including the phases of filling the plate filter press with the suspension to be filtered; filtration of the suspension and concomitant formation of porous filter cakes on the filter media, discharging; homogenizing the filtrate.

The present invention relates to a method for the production of substitute products for dairy products from plant-based raw materials as well as the use of equipment for the solid-liquid separation of suspensions, to produce extracts, beverages or derived products (yoghurts, creams, etc.), also called “plant-based products”, in the agri-food industry.

### INTRODUCTION

Dairy substitutes are becoming more and more popular. In recent years, their consumption has rapidly increased. They respond to consumer needs, whether ethical or health-related, and are part of the growing interest in “vegan” products. They have interesting properties, especially from an environmental and nutritional point of view, for example for people who are lactose intolerant or allergic to milk. In particular, they are rich in fibre and fatty acids. See “Plant_based.milk.substitutes¿Bioactive.compounds?.conventional.and.novel.processes?.bioavailability.studies?.and.health.effects” Journal of Functional Foods (2020)—Elsevier; Elif Feyza Aydar, et al.

As a substitute for milk, there are beverages made from the suspension of plant materials and its extracts in water. The following plant materials are distinguished:
nuts: almonds, walnuts, hazelnuts, cashews, macadamia nuts;
cereals: barley, wheat, spelt, rice, oats;
leguminous plants: soybeans, peas, peanuts;
coconut;
seeds: sunflower, hemp;
tubers: potatoes, cassava, . . .

The production processes of these dairy substitutes can be improved, particularly for the separation of soluble and macronutrient fibres, from insoluble fibres, commonly known as spent grains or “okara”.

### STATE OF THE ART

For the production of plant-based milks, the separation of soluble fiber and macronutrients, from insoluble fibers is usually achieved with decanter centrifuge technology. The use of centrifugal force has the advantage of being able to clarify suspensions of any type, with regard to the raw material and its pre-treatment. This technique also makes it possible to set the percentage of dry matter in the filtered product.

Document WO 2014/123466 describes a process for producing a liquid oat base for use as a milk substitute or as a food additive. The process includes milling, enzymatic treatment, liquid-solid separation, ingredient addition, heat treatment, homogenization and packaging. The liquid-solid separation step is carried out using a decanter, it can be omitted.

Document EP 0 731 646 B1 describes a process for preparing a suspension of cereals, in particular oats, which includes the steps of grinding, suspension in water, possible solid-liquid separation to remove coarse fibrous particles, enzymatic treatment, homogenization, sterilization. The solid-liquid separation step is carried out by centrifugation (Example 2) or decanting (claims).

Document EP 2 476 317 describes a process for producing an almond drink. The process includes the steps of drying the almonds, dry grinding, dispersion of the almond paste in an aqueous medium, possible heat treatment and optional packaging. No liquid-solid separation steps are described.

Document DE 2020211101792 U1 describes a process for preparing a fermented plant extract for milk substitutes. The process involves the steps of liquefaction of the starch contained in a plant material, in particular oats, with the possible addition of enzymes; possible dilution; solid-liquid separation to remove insoluble components; fermentation; then filtration to remove yeast. In the examples of realisation, solid-liquid separation is achieved by centrifugal decantation.

Centrifuge decanters are efficient in terms of solid-liquid separation, they allow the separation of particles based on their density difference under the effect of centrifugal force at speeds ranging from 1500 to 10000 g (gravitational force). This operating principle results in a high power consumption. On the other hand, the losses of “extract”, especially in the solid residue (“okara”) are high. Indeed, at the exit of the decanter, the okara has a humidity of around 75%. This percentage of okara moisture is therefore made up of the “extract”, which is found in a by-product and is not recovered. This is a significant loss of yield in the overall manufacturing process.

Since the separation in a decanter centrifuge is in continuous mode, it is not possible to wash the solid residue during the separation cycle in the same equipment. Washing is possible if the solid residue from the separation is resuspended in water and then subjected to a second separation by decanter centrifuge. This process involves the use of two decanters placed in series, or the reuse of the decanter intended for separation for a washing cycle. Both options are expensive and unattractive in terms of cycle time and yield.

In the field of filtration, there are different types of filters, including so-called “plate filter press”.

The applicant supplies industrial equipment, including a filter press for the filtration of brewery or distiller's mash and the separation of spent grain from wort; clarified wort being used in the manufacture of beer, alcohol or extract.

Plate filter presses consist of a plurality of vertical plates assembled to each other by their peripheral frame. A filter media, usually a flexible cloth, is stretched over each plates in such a way as to delimit, on either side of the filter support: a filtration chamber, and a filter collecting chamber. The filter media is attached to the plate. As filtration progresses, the suspension to be filtered is introduced into the filtration chamber, a filter cake forms on the filter media and the filtrate is recovered into the collecting chamber and then flows through the collecting channels.

Each plate can have an elastomeric membrane that allows the compression of the filter cake through the introduction of a compression fluid. These filters are also called thin bed filters. Such a filter is described, for example, in documents EP 2 248 571 A1 and EP 3 138 620 B1.

The purpose of the present invention is to provide a method for processing plant based raw materials for the production of a base for producing extracts, beverages or derived products (yoghurts, creams, etc.), also called “plant-based products”, in the food industry.

It has been discovered that it is possible to improve the performance of these processes by using a filter press, particularly a membrane filter, for the solid-liquid separation step following the suspension and eventual hydrolysis step.

Another goal is to offer a process that consumes less electrical and thermal energy.

The present invention relates to a method for producing dairy substitutes that comprises at least the following steps:
suspension of a plant-based material containing compounds to be extracted;
solid-liquid separation by means of a plate filter press which comprises at least filtration chambers and filter media, said solid-liquid separation step comprising the phases of:
   filling the filter with the suspension to be filtered;
   filtration of the suspension and concomitant formation of porous filter cakes (consisting at least in part of the insoluble elements contained in the suspension);
   possible washing the filter cakes, in order to recover most of the extract present in the cakes;
   discharging;
homogenization of the filtrate.

The homogenization of the filtrate results in a stable colloidal drink.

Filter cakes are mainly made of the insoluble materials contained in the starting plant material. If the plant material contains a small part of insoluble material, additional insoluble material can be added to the suspension before filtration to assist in the formation of the porous filter cakes.

Plant-based raw materials are chosen from nuts such as almonds, walnuts, hazelnuts, cashew nuts, macadamia nuts; cereals such as barley, wheat, spelt, rice, oats; leguminous plants such as soybeans; peanuts; coconuts; seeds such as sunflower, hemp; tubers such as potato and cassava. Most of these materials contain starch.

During the suspension stage, in particular in water, macromolecules such as starch and proteins contained in the starting vegetable material are solubilized or even hydrolyzed into simple molecules (sugars, dextrins, amino acids, low molecular weight proteins, soluble beta-glucans, etc.). It is preferable that there is hardly any residual starch left in the suspension to be filtered, otherwise the cakes and filter media could become clogged.

Advantageously, the ratio by weight of water to raw material is between 0.5 and 6, preferably between 1.5 and 5, and still preferably between 2 and 4. This ratio can be adapted according to the raw materials used.

To carry out hydrolysis, the suspension is heated to different temperature levels with or without the addition of enzymes. The suspension can be heated indirectly or directly by injecting steam into the suspension.

Cooling steps can be interspersed between the heating rests.

The temperature and pH must be adapted according to the raw materials used, the final composition of the desired product and the type of enzymes used. Other additives can be added during suspension (calcium, acid or base to modify the pH, anti-oxidant etc . . . )

At the end of hydrolysis, the solid-liquid separation step aims to separate soluble fibers and macronutrients from insoluble fibers (commonly known as “okara”).

When the solid-liquid separation stage includes a phase of sparging the filter cakes, this is done by pumping water that percolates through the filter cakes. The temperature of the sparging water is preferably between 60 and 95° C., preferably between 70 and 85° C.

Preferably, the Filter Press Has Elastomeric Membranes.

In this case, the method of the invention comprises at least the following steps:
suspension of a plant-based material containing compounds to be extracted;
solid-liquid separation by means of a membrane plate filter press which comprises at least filtration chambers and a filter media, said solid-liquid separation stage comprising the phases of:
   filling the filter with the filter suspension;
   filtration of the suspension and concomitant formation of porous filter cakes (consisting at least in part of the insoluble elements contained in the suspension) on the filter media;
   pre-compression of the filter cakes in order to recover the maximum extract and homogenize the cakes;
   sparging of the filter cakes, in order to recover most of the extract present in the cakes;
   compression to reduce the moisture content of the cakes;
   discharging;
homogenization of the filtrate.

The pre-compression of the cakes is carried out by inflating the membranes with a compression fluid. This can be water or air.

In particular, a pre-treatment is carried out before suspension. This pre-treatment may include a step of partial or total removal of the hulls of the plant-based raw material; It may involve soaking and/or heat treatment by steam or indirect heating. Soaking can be done in room temperature water or hot water. The composition of the soaking water can be adapted, in particular it may include additives, for example to adapt the pH.

Depending on the raw materials used, for process reasons or for the organoleptic qualities of the finished product, they can be quenched, bleached or de-oiled before crushing.

According to a particular mode of the invention where the material consists of whole cereal grains, the removal of the hulls involves the subtraction of 2 to 30% by weight of the raw material (preferably from 5 to 20%).

The different pre-treatment steps can be switched.

Depending on the raw material used, the pre-treatment may include milling. This can be wet or dry milling. Mill can be impact, colloidal or disc type mill. Double milling (dry and wet) is also possible.

Milling is advantageous to obtain a particle size between 50 μm and 1800 μm, preferably between 100 μm and 1000 μm, preferably between 125 μm and 500 μm.

The method according to the invention may also include one or more post-treatments.

Once solid-liquid separation has been completed, the “juice” or “wort” or “filtrate” can be cooled, and then processed downstream.

For example, for the manufacture of a “plant-based milk”, it can undergo the formulation, homogenization and heat treatment (UHT) stages of sterilization, before packaging. Additives are potentially added to provide consistency, vitamins, an effect of colour, texture, taste: salts, oil, flavourings, etc.

Homogenization is an important step that aims to improve the physical stability of the final product. It is generally carried out by stirring with rotor/stator mixers producing high shear, or with so-called pressure homogenizers (low, high, ultra high pressure piston pumps). The aim of this operation is to reduce the particle size and improve the stability of the final product as well as its whiteness

In particular, stirring can be carried out at a speed between 2000 and 4000 rpm, for a period of 5 to 15 min.

The subject matter of the invention is also the use of a filter press comprising a plurality of filtration chambers and a plurality of filter media, for the solid-liquid separation of a suspension of a plant-based raw material comprising compounds to be extracted.

Other advantageous modes are described in the sub-claims.

The present invention is particularly suitable for processes using thin bed filters, i.e. with a filter cake layer between 20 and 100 mm, such as the Meura 2001 filter press.

### EXAMPLE OF REALIZATION

The present invention is now described, by way of example, by reference to the annexed drawings, in which:

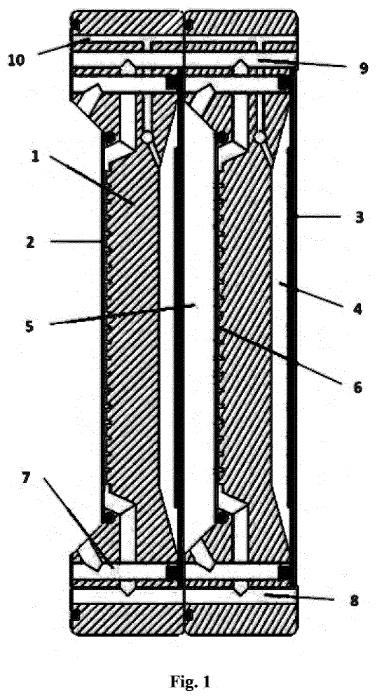

FIG. 1 shows a cross-sectional view of two support plates;

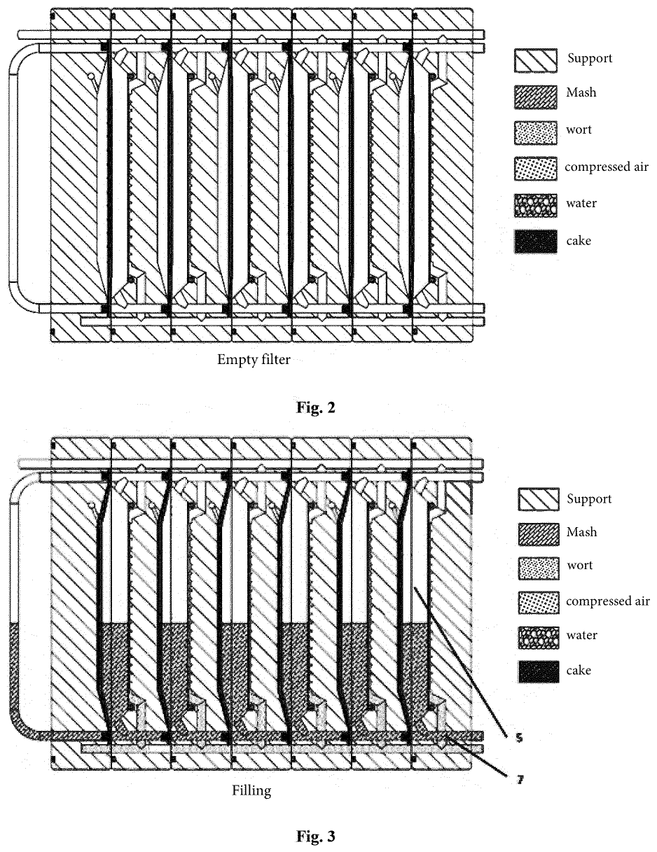

FIGS. 2 to 9 show a cross-sectional view of a filter press, with five support plates, each fig. representing a different step in the solid-liquid separation process.

In FIG. 2, the filter is empty.

FIG. 3 illustrates the filling step.

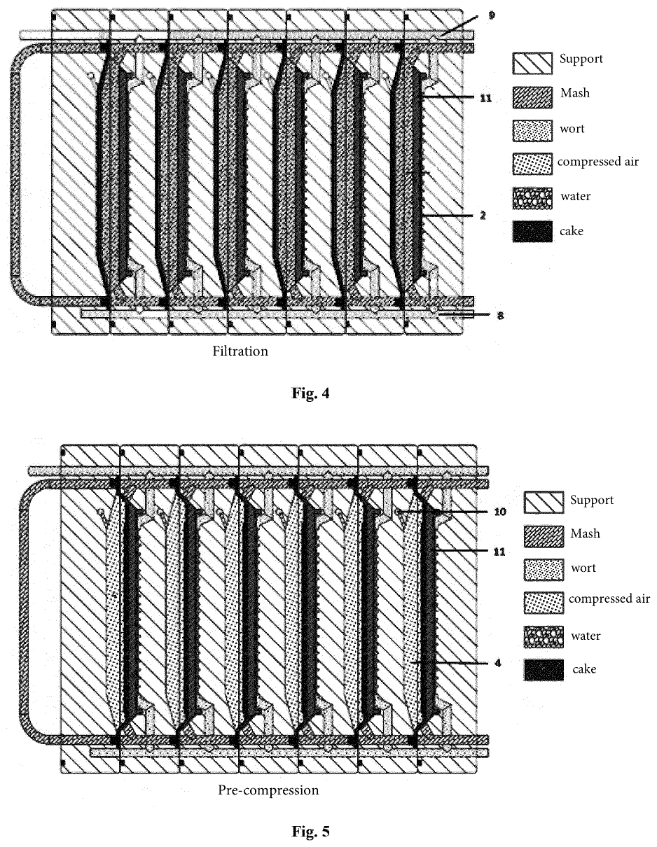

FIG. 4 illustrates the filtration step.

FIG. 5 illustrates the pre-compression step.

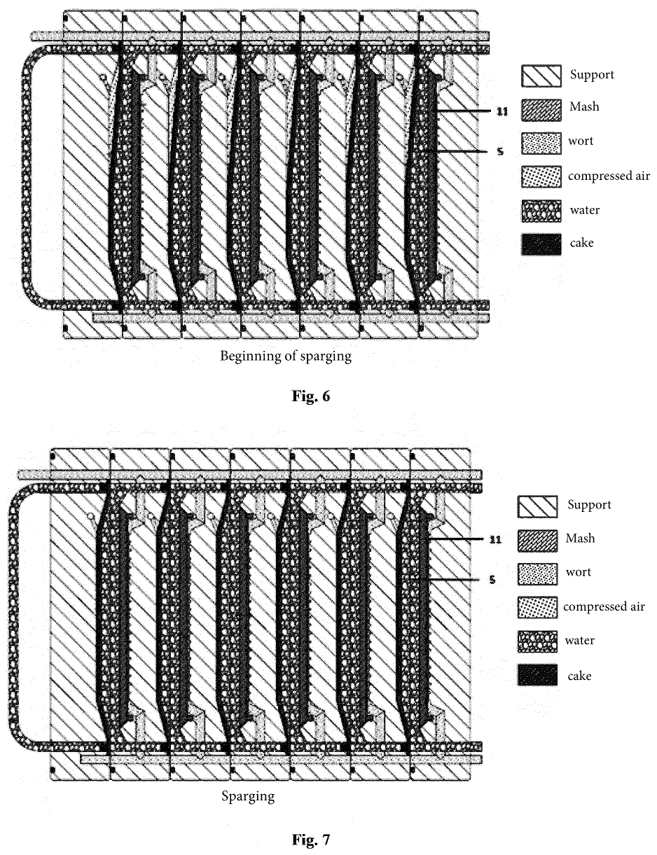

FIG. 6 shows the beginning of sparging.

FIG. 7 illustrates the sparging step.

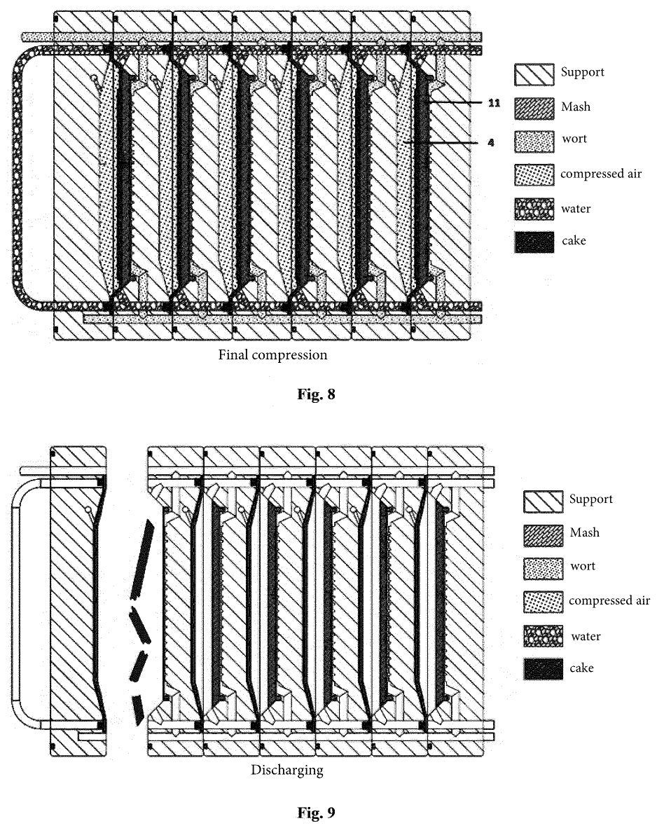

FIG. 8 illustrates the final compression step.

FIG. 9 illustrates the discharging stage.

FIG. 1 shows two support plates 1 joined by their peripheral frames. Each plate 1 has a filter cloth 2 on one side and a flexible elastomeric membrane 3 on the other side. This forms a succession of compression chambers 4, filter chambers 5 and collecting chambers 6. Plates may have one or more central bosses (not shown).

The side of the plate facing the filter cloth may have filter drainage pads. Filter chamber 5 is connected to a bottom inlet or supply channel 7. The collecting chamber is connected to a lower 8 and upper 9 collecting channel. Compression chamber 4 is connected to a compression fluid supply channel 10.

### Example 1

This example details a method of producing oat milk based on raw oats from which some of the hulls of the grains have been removed.

### Pre-treatment of Raw Materials

Oat kernels have special properties in terms of composition and structure; they require different processes compared to other grains.

For the production of oat milk, whole oat grains are usually dehulled, their hulls being indigestible and undesirable for organoleptic reasons of the finished product.

In the present invention, however, it is necessary to form a porous cake to ensure good filtration efficiency. In addition, a sparging of this filter cake can be carried out, in order to recover as much extract as possible.

A complete dehulling of the oat kernels would not leave enough insoluble compounds for the formation of such a filter cake. The inventors noticed that if the hulls of the oat kernels are completely removed, the filtration can cause clogging problems.

In order to establish a compromise between the filterability of the filter suspension and the organoleptic quality of the product, the applicant processed the oat kernels with a view to partially eliminating the hulls.

Different techniques exist to separate some or even all of the hulls, before or after crushing the whole grains. In this example, the inventors chose to eliminate a portion of the hull fraction after crushing the oat kernels.

### Milling

The pilot mill used is a hammer mill equipped with a 9.2 KW motor. The motor drives four rows of six hammers. A forced ventilation system allows the fine particles produced during the milling process to be carried away and trapped on fabric filter sleeves in order to avoid the risk of explosion within the mill.

The sieve installed for milling has perforations with a diameter of 3 mm.

After milling, the entire grist is passed through a vibrating sieve (Russell Finex EcoSeparator, 2 mm sieve, 30″) to separate a part of the hulls (dehulling). The coarsest fraction retained on the sieve, mostly hulls, is separated from the rest of the grinding and represents 17% of the total grain mass.

### Suspension (Mashing/Hydration)

The resulting grist (partially stripped of the hulls) is then driven by a screw to a hydrator allowing it to be mixed with water. The mash water temperature is set at 55° C., and the total amount of water is set to obtain a final water ratio of 2.5 litres of water per kg of grist.

This water/grinding ratio, which is reduced compared to oat milk production according to the state of the art, is inherent in the use of a plate filter press. Indeed, a filter press filtration cycle advantageously includes a sparging step allowing the recovery of the extract contained in the filter cakes. The final concentration of the juice after solid-liquid separation therefore includes the quantities of water introduced at the suspension stage and at the sparging stage during the filtration cycle. The ratio of hydration is defined on this basis.

Working with more concentrated suspensions also reduces the thermal energy consumption associated with the upstream stages of liquid-solid separation.

In this example, 42 kg of partially dehulled raw oats were milled and mixed with 105 L of water at 55° C., i.e. a ratio of 2.5 L of water/kg of oat grinding.

It is estimated that the thermal energy required to heat and cool this suspension during hydrolysis is about 30% lower than that of a suspension with a ratio of about 4-5 L of water per kg of oat grinding.

After correcting the pH to 6 with phosphoric acid and adding an alpha-amylase to promote the conversion of starch into simple sugars, the suspension obtained is subjected to a hydrolysis diagram optimized for the action of these enzymes:
30 min at 75° C.
rise to 85° C.

This is a simple hydrolysis diagram, other recipes involving other enzymes and other temperature levels can of course be considered according to the desired composition of the finished product (sugars, proteins, beta-glucans, etc.).

Heating with a temperature increase of 1° C./min and temperature maintenance at the various stages are ensured by direct injection of low-pressure steam (Meura's “Aflosjet ®” system) into the product.

This results in a suspension of hydrolyzed oats.

### Solid-liquid Separation

The suspension is then filtered using a four-chamber “Meura 2001 Hybrid Micro” filter with a total nominal capacity of 44 kg of malt equivalent (11 kg per chamber). The filtration cycle follows the following steps:
Filling (FIG. 3): the suspension is sent to the filter using a centrifugal pump operating at constant speed, through supply channels 7, so as to fill the filter chambers 5, in 2 to 4 minutes.
Filtration (FIG. 4): the rest of the suspension is transferred to the filter, the filtering effect being provided by the gradual formation of cakes 11 consisting of the insoluble materials of the suspension on the filter cloths 2. The suspension is first sent at a constant flow rate (7.5 L/min) until it reaches the control pressure (450 mbar) and then maintains this pressure within the filter. The total volume of suspension is transferred to the filter in 21 minutes, and 71 L of dense juice at 16.9°Plato is collected through collecting channels 8 and 9. A Plato unit represents the mass percentage of extract in the filtrate.
Pre-compression (FIG. 5): air (450 mbar) is injected for 5 minutes, through the supply channels 10 into the compression chambers 4 of each of the filter elements in order to precompress the previously formed filter cakes 11. This step allows an additional 8 L of dense juice to be recovered and to homogenize the porosity of the cakes for an efficient sparging.
Sparging (FIGS. 6 and 7): 65 L of water at 85° C. are then sent in 61 minutes to the filtration chambers 5 and passed through the filter cakes 11 to recover as much of the extract as possible from them. During this stage, the density of the juice at the outlet of the filter gradually decreases as the water carries away the extract contained in the filter cakes to reach 1 to 2°P at the end of the sparging.
Final compression (FIG. 8): air is again sent into the compression chambers 4 (700 mbar) for 5 minutes in order to compress the cakes 11 and thus recover a maximum of extract while drying them to facilitate their dehulling. A total of 148 L of oat juice at 14.0°P were recovered in 1 hour and 34 minutes.
Discharging (FIG. 9): at the end of the cycle, the filter is opened and the filter cakes (okara) with 75% humidity are evacuated.

The main difference between this type of separation compared to a decanter centrifugal or high-pressure filter press separation without sparging is that the extract present in the filter cake (okara) is recovered and becomes an integral part of the final product.

The filtration and pre-compression stages will have made it possible to recover 79 L of juice at 16.9°P, which represents 65% of the total extract recovered during the filtration cycle. The final sparging and compression stages will have allowed 35% of the additional extract to be recovered.

### Post-processing (Formulation and Homogenization)

To obtain oat “milk”, the juice collected at the outlet of the filter is cooled, then diluted by adding water to obtain the desired final concentration, and transferred to a homogenization tank.

Sunflower oil (3.3 mL/L juice) and 20% NaCl solution (14 mL/kg grind) are added, and the mixture is homogenized. Stirring the mixture with a rotor/stator rotating at 3000 rpm (Mixturall, Boccard), for 10 minutes allowed a stable emulsion to be obtained.

### Example 2

This 2nd example details a method of producing oat milk based on raw oats that has undergone a pre-treatment consisting of partial dehulling followed by heat treatment with steam.

### Pre-treatment of Raw Materials

The pre-treatment of raw materials aims to improve the organoleptic qualities of the finished product and is done here in 2 distinct interchangeable steps:
1. Partial separation of the hulls from the grain, taking care to keep a certain proportion of hulls necessary for the formation of the filter cake during the solid-liquid separation stage
2. Heat treatment of grains

For the first stage, the oats have the particularity of having an hull that is easily dissociated from the endosperm, which is separated from the grain by means of an impact dehuller before being eliminated by an aerodynamic separation system. This makes it possible, starting with 60 kg of raw oats, to eliminate 12 kg of hull, i.e. 20% of the total mass of the grains.

Then, in the 2nd step, the remaining fraction, mostly made up of naked grains, will undergo heat treatment. Indeed, given their high lipid content, oats are particularly sensitive to oxidation that can make the final product rancid if no heat treatment is applied beforehand. In this example, the treatment applied is a 20 minutes steam contact.

### Milling/Hydration

In this 2nd example, wet milling was applied. The pilot mill used is a hammer mill equipped with an 18.5 kW motor. The motor drives four rows of eleven hammers. The installed sieve has perforations of 3 mm diameter. A mixture of water and grains is made in the milling chamber.

The grain feed rate is set at 2.4 kg/min and the water flow rate at 4.8 L/min in order to achieve an instantaneous mashing ratio of 2 L/kg. The grains, still hot from the steam treatment, are milled and mashed simultaneously with mashing water at 25° C., so that the final temperature reaches about 55° C. The mash water also contains additives (KMS and Calcium) and enzymes (alpha-amylase 10 kg/T of oats) necessary for mashing and hydrolysis.

A certain volume of rinse water is used at the end of the milling process to carry the residual particles out of the milling chamber. This volume of water is set in such a way as to achieve a total mash ratio of 2.3 L/kg. Thus, 43.7 kg of pre-treated oats were mixed with 100.6 L of water.

After grinding, the resulting suspension is continuously pumped from a buffer tank to the hydrolysis tank.

### Hydrolysis

After correcting the pH to 6 with phosphoric acid, the suspension, which also contains the enzymes that promote the conversion of starch into simple sugars, is subjected to a hydrolysis diagram optimized for the action of these enzymes:
Initial temperature at 55° C.
30 min at 75° C.
Rise to 85° C.

Heating with a temperature increase of 1° C./min and temperature rest at the various stages are ensured by direct injection of low-pressure steam (Meura's “Aflosjet®” system) into the product.

This results in a suspension of hydrolyzed oats. A control test with an iodine solution (0.02 N solution to be brought into contact with the suspension) confirms (neutral coloration) or not (black/purple coloration) the starch conversion.

### Solid-liquid Separation

The suspension is then filtered using a four chambers “Meura 2001 Hybrid Micro” filter with a total nominal capacity of 44 kg of equivalent malt (11 kg per chamber). The filtration cycle follows the following steps:
Filling (FIG. 3): the suspension is sent to the filter using a centrifugal pump, through the supply channels 7, so as to fill the filter chambers 5, in 2 to 4 minutes.
Filtration (FIG. 4): the rest of the suspension is transferred to the filter. The total suspension volume is transferred to the filter within 9 minutes. The pressure gradually builds up as the cake is formed, reaching 0.4 to 0.5 bar. 70 L of dense juice at 18.8°Plato is recovered through collecting channels 8 and 9.
Pre-compression (FIG. 5): the injection of air (350 mbar), through the supply channels 10 into the compression chambers 4 of each of the filter elements, allows the recovery of an additional 33 L of dense juice and homogenizes the porosity of the cakes for an efficient sparging. This step lasts 5 minutes.
Sparging (FIGS. 6 and 7): 38 L of water at 85° C. are then sent in 14 minutes to the filtration chambers 5 and passes through the filter cakes 11 to recover as much as possible of the extract they contain.
Final compression (FIG. 8): air is again sent into the compression chambers 4 (700 mbar) for 8 minutes in order to compress the cakes 11 and thus recover a maximum of extract while drying them to facilitate their dehulling. Compression allows an additional 25 L of juice to be recovered.

A total of 168 L of “oat juice” at 14.6°P were collected in 38 minutes. The turbidity of the juice is measured at 748 FAU and the amount of sediment 2 g/100 g of juice.
Discharging (FIG. 9): at the end of the cycle, the filter is opened and the filter cakes (okara) with 58% humidity are evacuated.

### Post-treatment (Formulation—Homogenization)

To obtain oat “milk”, the juice collected at the outlet of the filter is cooled using a plate exchanger, then diluted by adding water to obtain the desired final concentration of 13°P, and transferred to a homogenization tank.

Sunflower oil (10 mL/L of juice) and a solution of 20% NaCl (3.7 mL/L of juice) are added, and the mixture is homogenized. Stirring the mixture with a rotor/stator rotating at 3000 rpm (Mixturall, Boccard), for 10 minutes allowed a stable emulsion to be obtained.

### Advantages

The advantages of using the membrane bed filter are as follows:
produce clarified juice in an optimized cycle time;
recover most of the extract from the hydrolyzed suspension, thanks to the sparging of the filter cakes;
produce an okara with a reduced humidity level, which lowers the risk of contamination, transport and storage costs.

The invention also made it possible to optimize the efficiency of the separation cycle compared to state-of-the-art technologies. In particular, the sparging step makes it possible to recover almost all of the residual extract in the filter cakes (spent grains or okara).

The invention also makes it possible to reduce the electrical and thermal consumption of the process. When part of the water to be incorporated into the product to reach the final concentration is added at the sparging stage, the operations upstream of the filter (hydrolysis) are carried out at a higher concentration (reduced ratios water/kg of material); As a result, smaller volumes of suspensions need to be heated in the tanks before filtration.

Another advantage is that the filter press does not require high-power electric motors such as decanter centrifuges.

1. A method for the production of dairy substitutes, the method comprising:
providing a suspension of a plant-based material containing compounds to be extracted;
performing a solid-liquid separation by a plate filter press comprising at least one succession of filtration chambers and filter media said solid-liquid separation comprising the phases of:
filling the plate filter press with the suspension to be filtered;
filtration of the suspension and concomitant formation of porous filter cakes on the filter media;
discharging;
homogenizing the filtrate.

2. The method according to claim 1, comprising performing a step of pre-treatment of the raw material, prior to the step of suspension.

3. The method according to claim 2, wherein the pre-treatment comprises a heat treatment step of the raw material.

4. The method according to claim 3, wherein the pre-treatment comprises a step of soaking the raw material.

5. The method according to claim 2, wherein the pre-treatment involves milling the plant-based raw materials.

6. The method according to claim 2, wherein the pre-treatment comprises a step of dehulling the raw material removing from 2 to 30% by weight of the raw material.

7. The method according to claim 6, wherein a mash water is introduced in a weight ratio of water to plant-based material comprised between 0.5 and 6.

8. The method according to claim 1, wherein at the suspension stage the suspension is raised to several temperature levels, with or without the addition of enzymes.

9. The method according to claim 1, wherein the solid-liquid separation is carried out at a pressure of less than 2 bar.

10. The method according to claim 1, wherein the solid-liquid separation comprises a phase of sparging the filter cakes.

11. The method according to claim 10, wherein the plate filter press comprises elastomeric membranes; at the end of filtration, the elastomeric membranes are inflated with a fluid to exert compression on the filter cakes.

12. The method according to claim 11, wherein at the end of sparging, the elastomeric membranes are inflated with the aid of a fluid to exert compression on the filter cakes.

13. The method according to claim 1, wherein the homogenizing comprises high-shear agitation.

14. The process according to claim 1, wherein the homogenizing is carried out in a pressure homogenizer.

15. The process according to claim 1, further comprising a formulation step.

16. The process according to claim 1, wherein the plant-based materials are selected from nuts; cereals; leguminous plants; seeds; tubers.

17. A method comprising providing a filter press comprising a succession of filtration chambers and filter media for the solid-liquid separation of a suspension of a plant-based raw material comprising compounds to be extracted for the production of a substitute for dairy products, wherein solid-liquid separation comprises:
filling of filtration chambers;
filtration of the suspension and concomitant formation of porous filter cakes on filter media;
sparging the filter cakes;
discharging.

18. The method according to claim 17, wherein the solid-liquid separation comprises at least one compression phase of the filter cakes.

19. The method according to claim 18, wherein a compression phase is carried out before the sparging of the cakes.

20. The method according to claim 18, wherein a compression phase is carried out after the sparging of the cakes.
